(19) United States
(12) Patent Application Publication
(10) Pub. No.: US 2024/0427579 A1
(43) Pub. Date: Dec. 26, 2024

(54) CONTROLLING CONTAINER IMAGE OPERATIONS IN COMPUTER ENVIRONMENT

(71) Applicant: International Business Machines Corporation, Armonk, NY (US)

(72) Inventors: Timo Kussmaul, Boeblingen (DE); Elton de Souza, Scarborough (CA); Sandeep N. Batta, Cary, NC (US); Peter Phillip Lundgren Szmrecsanyi, North York (CA); Robert Avill, Southampton (GB)

(21) Appl. No.: 18/337,753

(22) Filed: Jun. 20, 2023

(51) Int. Cl. G06F 8/41; G06F 8/36; G06F 21/60; H04L 9/08

(52) U.S. Cl. CPC G06F 8/447; G06F 8/36; G06F 21/602; H04L 9/0861

(57) ABSTRACT

A method, computer program product, and computer system for building container images comprise a base container image control agent associated with a base container image and a build system control agent associated with a build system. A mutual negotiation protocol is facilitated between the base container image control agent and the build system control agent. A set of operation parameters is determined in response to facilitating the mutual negotiation protocol. Identified from the set of operation parameters a set of requirements for a new container image control agent. A new container image is generated based on the operation parameters to which the new container image control agent is associated.

### BACKGROUND

Embodiments of the present invention relate to a containerized computing environment, and more specifically, to the controlling of reuse, evolution, and derivation of container images.

### SUMMARY

Embodiments of the present invention provide a method, a computer program product, and a computer system, for building container images.

One or more processors of a computer system determine a base container image control agent associated with a base container image and a build system control agent associated with a build system. The one or more processors facilitate a mutual negotiation protocol between the base container image control agent and the build system control agent. The one or more processors determine a set of operation parameters in response to facilitating the mutual negotiation protocol. The one or more processors identify from the set of operation parameters a set of requirements for a new container image control agent. The one or more processors generate a new container image based on the operation parameters to which the new container image control agent is associated.

### BRIEF DESCRIPTION OF THE DRAWINGS

FIG. 1 is a block diagram illustrating an environment for building and controlling operations of container images, in accordance with embodiments of the present invention.

FIG. 2 is a flow diagram illustrating a container image controlled during an operation, in accordance with embodiments of the present invention.

FIG. 3 is a flow chart of a method for controlling a lifecycle of a container image, in accordance with embodiments of the present invention.

FIG. 4 is a flow chart of a method for electronic communication between control agents of a software container and a build system, in accordance with embodiments of the present invention.

FIG. 5 is a block diagram illustrating an environment for building and controlling operations of container images using a central controller communicating with a plurality of build systems, in accordance with embodiments of the present invention.

FIG. 6 depicts a schematic view of an environment for building and controlling operations of one or more container images according to a blockchain smart contract, in accordance with embodiments of the present invention.

FIG. 7 illustrates an embodiment of a computer system, in accordance with embodiments of the present invention.

FIG. 8 depicts a computing environment which contains an example of an environment for the execution of at least some of the computer code involved in performing the inventive methods, in accordance with embodiments of the present invention.

### DETAILED DESCRIPTION

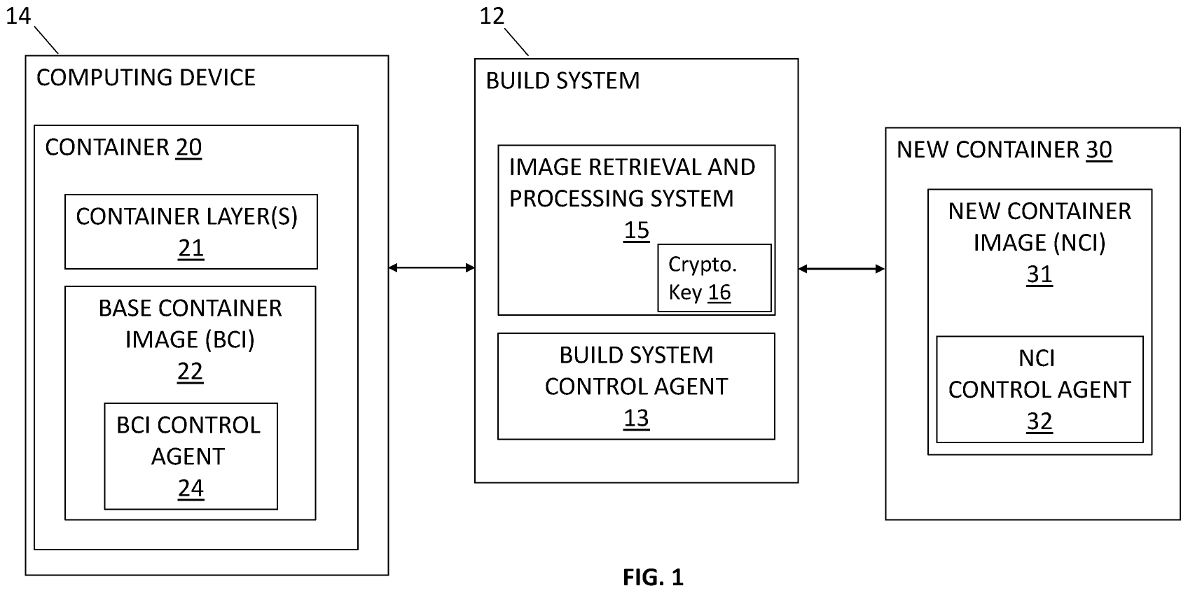

FIG. 1 is a block diagram illustrating an environment 10 for building and controlling operations of one or more container images, in accordance with embodiments of the present invention.

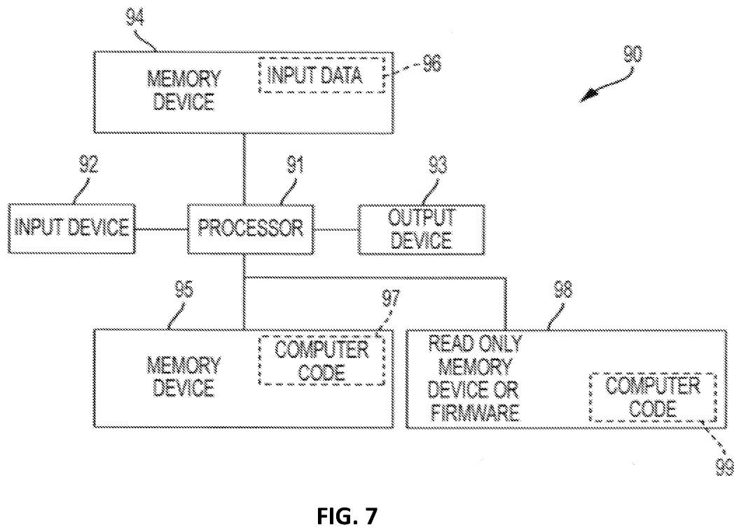

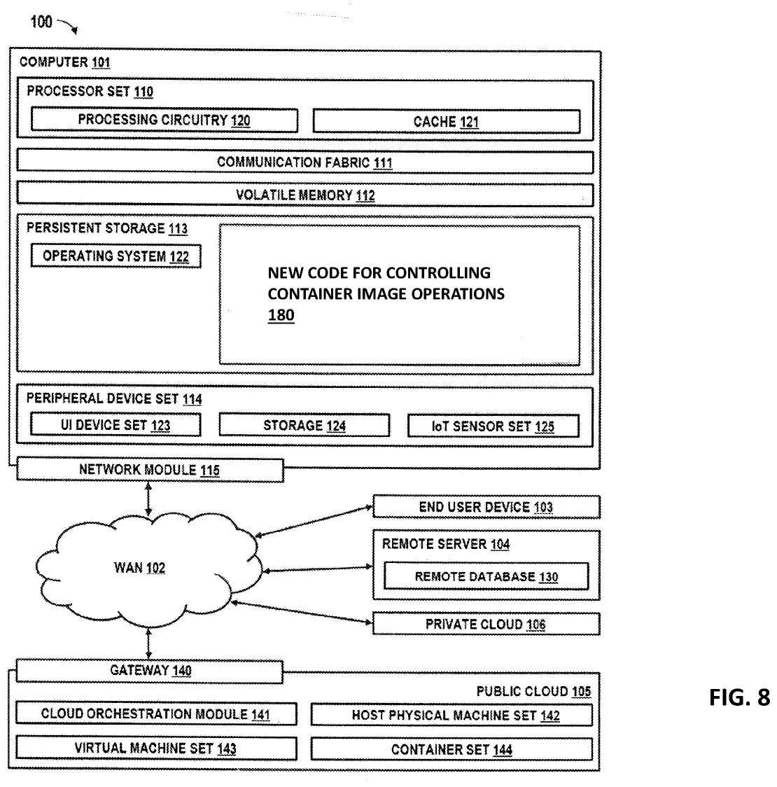

The environment 10 includes a build system 12 and a computing device 14, which communicate to allow a user such as an owner of a container image to control reuse and non-trivial operations of the container image such as derivation and transformation. The build system 12 and the computing device 14 can each include physical components such as one or more processors, non-transitory computer readable medium or memory, input/output (I/O) interface devices, and/or peripheral devices, which are not shown in FIG. 1 but described in other embodiments of a computing system, for example, FIGS. 7 and 8.

Stored and executed at the computing device 14, for example, a computer readable medium or memory, is at least one software container 20, generally referred to as a container. The container 20 can access and share an operating system kernel or the like with other containers. Each container 20 uses a predetermined amount of hardware resources (e.g., processor, memory, etc.) in the underlying hardware layer (not shown). Accordingly, the container 20, as would be known to a person of ordinary skill in the art, is constructed to isolate software applications or the like from the underlying hardware layer.

In some embodiments, the container 20 includes a base container image 22 formed of one or more layers representing different files that form a filesystem of the container 20. One or more files, or container layers 21, are built on the base container image 22 in subsequent stages, where each layer is dependent on the layer below it. The hierarchy of layers 21 is formed during the lifecycle of the base container image 22 of the container 20 stored and processed at the computing device 14. The base container image 22 can be shared across different software containers. A container layer 21 distinguishes the container 20 from other containers sharing the same resources.

The base container image 22 includes a base container image (BCI) control agent 24 that controls an instantiation of the reuse, derivation and evolution lifecycle of the base container image 22, and permits the base container image 22 to be used as a base image for building a new container image 31. The base container image 22 controlled by the BCI control agent 24 is also referred to as a “controlled base container image.”

The build system 12 includes an image retrieval and processing system 15 for building container images, for example, building the new container image 31 from the base container image 22. The image retrieval and processing system 15 obtains a container image, for example, base container image 22 or new container image 31, that includes a software application, and in some embodiments uses cryptographic (Crypto.) key 16 to encrypt one or more lower layers of the container image. In doing so, the image retrieval and processing system 15 generates an encrypted software container image that includes an encrypted version of the software application. The image retrieval and processing system 15 can also provide a decryption key to a computing device hosting the container image for decrypting the container image.

The new container image 31 includes a new container image (NCI) control agent 32 that controls an instantiation of the reuse, derivation and evolution lifecycle of the new container image 31, and permits the new container image 31 to be used as a base image for building one or more subsequent container images. The new container image 31 controlled by the NCI control agent 32 is also referred to as a “controlled new container image.”

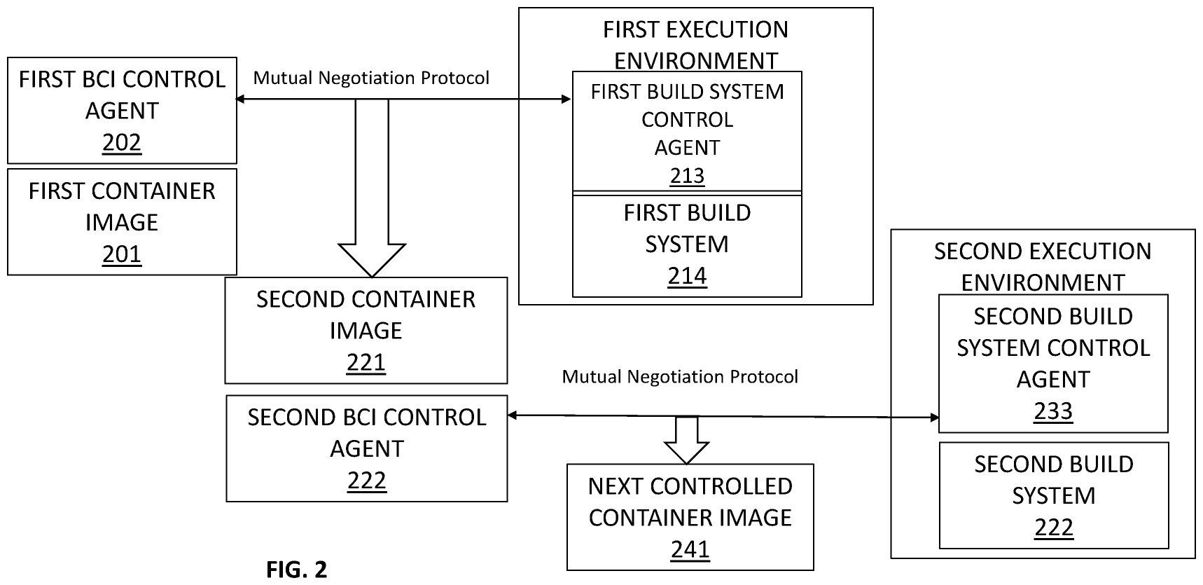

FIG. 2 depicts a flow diagram illustrating a container image controlled during an operation, in accordance with embodiments of the present invention. The operation shown in FIG. 2 allows an owner of a container image to control how their container image is used as a base container image. An operation can be a container image reuse operation, evolution operation, or derivation operation.

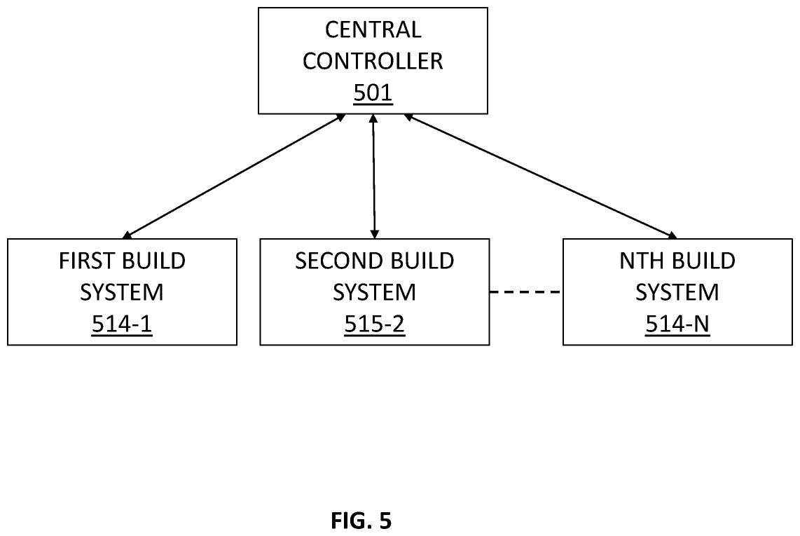

At the start of the operation, an owner of a first container image 201, e.g., the image creator, generates a first BCI control agent 202 for the first container image 201. In some embodiments, the first container image 201 and first BCI control agent 202 are similar to or the same as the base container image 22 and BCI control agent 24 in FIG. 1 so details are not repeated for brevity. In some embodiments, the first container image 201 includes multiple layers and is a new container image reused, evolved from, or derived from one or more base container images. In an embodiment, the first BCI control agent 202 is constructed to be a party to a contract created by the owner of the first BCI control agent 202 that defines the negotiation goals, requirements and constraints. In some embodiments, the first container image 201 is a base container image, which in turn is a first layer on which additional layers of a container image are added. In other embodiments, the first BCI control agent 202 is determined or identified, for example, by a central controller (see FIG. 5) that generates the first BCI control agent 202, for association with the first container image 201.

To initiate a process according to the flow diagram of FIG. 2, a first container having the first container image 201 receives an event indicating that the first container image 201 has been created, changed, added to, or otherwise informing the system that an operation is required for processing the first container image 201. In some embodiments, the environment 10 includes logic built into the containers, execution environments or container runtimes to determine what kind of reuse, derivation or transformation would be suitable or valid.

A first build system 214 includes a first build system control agent 213, which is invoked by the build system 214 to generate a second container image 221 from the first container image 201. The first build system control agent 213 is constructed to be a second party to a contract so that a mutual negotiation protocol can be exchanged with the first BCI control agent 202, and so that the first build system control agent 213 can invoke the first BCI control agent 202 to negotiate with the first build system control agent 213 about a requested build with respect to a second container image 221.

In some embodiments, the first control agent 202 and first build system control agent 213 are parties to a contract that defines the negotiation goals, requirements, and constraints. The first control agent 202 and first build system control agent 213 can engage in a mutual negotiation regarding requirements and parameters of the build and the build environment, data privacy and protection requirements, and further functional and non-functional aspects of the build. For example, only specific build steps, instructions, and parameters are permitted during builds that are based on the first container image 201. The resulting new or evolved container image, e.g., second container image 221, needs to be controlled, and in doing so requires the generation of a second BCI control agent 222. In some embodiments, in response to a negotiation with the first control agent 202, the first build system 214 is a trusted build system running in a trusted execution environment. In some embodiments, the trusted execution environment is represented by a set of requirements on attestation records. For example, a trusted build environment requires code verification, or attestation of authenticated statements of code identity.

The first BCI control agent 202 negotiates on behalf of the container image owner, and the first build system control agent 213 negotiates on behalf of the build system owner. To balance the requirements of the involved parties, e.g., the container image owner and the build system owner and their corresponding components, e.g., first container image 202 and first build system 214, a mutual negotiation protocol is exchanged including requirements and parameters of the build and the first execution environment of the first build system 214, as well as data privacy and protection requirements, and further functional and non-functional aspects of a build. By including this negotiation-based balance of interests, the mutual negotiation protocol exchange can settle the requirements and properties of the involved parties and components. This may include multiple iterations. In some embodiments, the second BCI control agent 222 is formed according to a new set of requirements and a corresponding set of requirements and properties identified from the negotiation protocol exchanged between the first BCI control agent 202 and first build system control agent 213, so that the second BCI control agent 222 can control future builds formed from the second container image 221, which becomes a base image when embedded with the second BCI control agent 222. During operation, from the set of operation parameters a set of requirements are identified for the new container image control agent 32. A property negotiated during an exchange between the first BCI control agent 202 and first build system control agent 213 may include a Boolean flag that permits the use of the new image as a base image. If not enabled, the new agent will reject any negotiation attempts to prohibit using the image as a base image. For example, an expiration date establishes that after a predetermined number of days (e.g., 360 days) no additional reuse is allowed. Another example includes a property which defines a central repository to use to download further requirements and properties. Other properties define acceptable counterparty agents and their execution environments, e.g., software version, or required attestation records which can be obtained and verified using a prior art remote attestation protocol or prior art local attestation. Here, an agent will allow negotiation with counterparties only if these can provide attestation records according to these properties.

In some embodiments, the contract is a smart contract or the like. The contract can include immutable scripts or programs executable by a decentralized computing environment. In some embodiments, the contract is created by the owners of the first control agent 202 and first build system control agent 213. In some embodiments, a third party such as a proxy agent may act of behalf of an owner as at least one of the first control agent 202 and first build system control agent 213. In some embodiments, a smart contract is in an executable or machine-readable format for processing by the control agents, for example, that defines the goals, requirements, and constraints of a container image defines requirements on a build. For example, the smart contract defines negotiation goals, requirements, and constraints for the mutual negotiation protocol between the first control agent 202 and first build system control agent 213. One example requirement is that only allow list build instructions are allowed during the build (the allow list is contained in the contract). Another example requirement is that only a certain build system is allowed (this fact is represented by a set or requirements on attestation records). Another example requirement is that the build is allowed only if the first build system 214 runs inside a trusted execution environment, e.g., represented by a set of requirements on attestation records. Another example requirement is that the resulting new container image must be associated with a control agent and a set of requirements that enforces the same set of controls.

After the negotiation including the use of the contract is performed, the second container image 221 is generated and has a second BCI control agent 222 that enforces the set of controls established by the contract. The second BCI control agent 222 is created for the second container image 221 so that future builds can be controlled. For example, the second container image 221 can be used as a base image to another controlled build, for example, second build system 232.

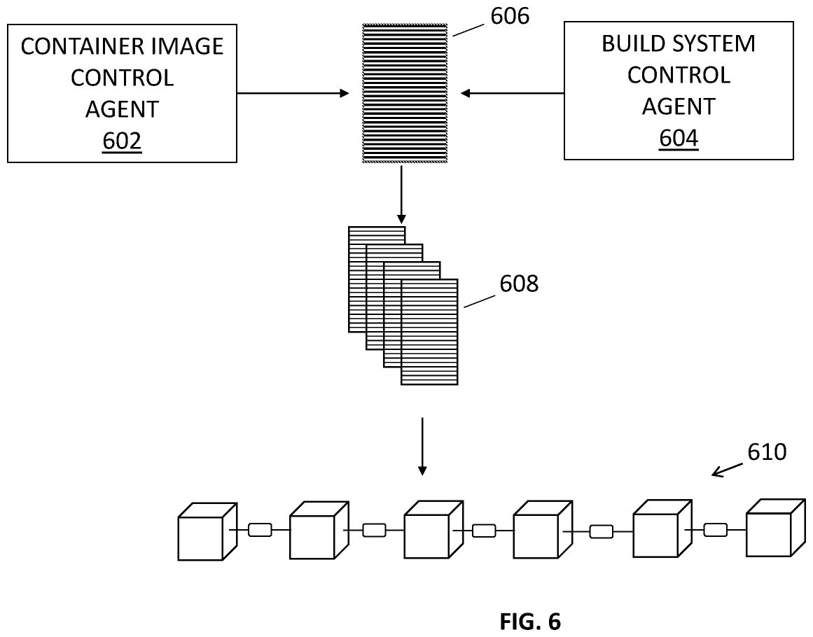

In this example, the first BCI control agent 202 copies the control agent implementation and contract from the first container image 201 to the second container image 221. In a more complex embodiment, the first BCI control agent 202 creates a new data encryption key to encrypt the layers and include a wrapped version of a data encryption key (DEK) into the new control agent, i.e., the second BCI control agent 222 to decrypt the layers. In some embodiments, an envelope encryption technique is applied where the DEK is encrypted by a key encryption key (KEK) managed by a key management system, for example, at a central computer server or a hardware-based security processing system that provides cryptographic operations including cryptographic keys that render the software of the image layers tamper-resistant, such as a trusted platform module (TPM). The first BCI control agent 202 also includes logic for communicating with the key management system into the new control agent, i.e., the second BCI control agent 222. Optionally, the first BCI control agent 202 pushes the key encryption key to the key management system or other hardware security processing system. Optionally, the first BCI control agent 202 and/or first build system control agent 213 store evidence about the build and the negotiation in a blockchain or a repository (see FIG. 6). The second container image 221 is now successfully built.

This way, the process is constructed in a way so it can be chained or repeated, i.e., the second container image 221 is a controlled image, too. For example, as shown, the second container image 221 can be a party to a new set of requirements with a control agent 233 in a second execution environment that includes a second build system 222, referred to as a second build system control agent 233.

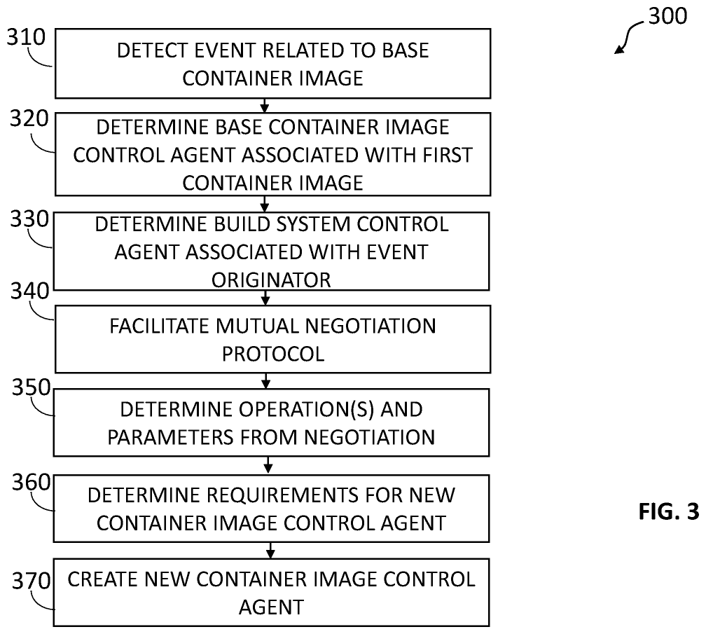

FIG. 3 is a flow chart of a method 300 for controlling a lifecycle of a container image, in accordance with embodiments of the present invention. In describing the method 300, reference is made to elements of FIG. 1. Accordingly, some or all of the method 300 is performed in the environment 10 of FIG. 1.

At step 310, an event related to a base container image 22 is detected. In some embodiments, a build system 12, which is configured to listen for events, such as a build request, or an event request for a build that triggers a negotiation protocol exchange. For example, an event may indicate that the base container image 22 is an open-source base image that is subject to an operation, such as reuse, where a current build uses a previous container image. In other embodiments, an event is received or detected from an originating source such as a runtime system, for example, a plugin to a container runtime hook point. In other embodiments, an event is received or detected from the build system 12 or other computer in communication with the build system 12 and/or computing system 14 that collects data that can inform the other computer whether an operation is required with respect to the base container image 22. In another example, an event may indicate that the base container image 22 is scanned as part of a security operation to verify the identity and integrity of the base container image 22. In another example, the container 20 may be triggered by an external event such as a user loading an application such as a web page.

At step 320, a BCI control agent 24 associated with the first base container image 22 is determined. In some embodiments, the BCI control agent 24 is created by an owner of the base container image 22, for example, to represent or act on behalf of the owner in a negotiation with the build system 12 over a subsequent build of another container image using the base container image 22. In other embodiments, the BCI control agent 24 is created remotely, for example, by a central controller (see FIG. 5) and embedded in the base container image 22.

At step 330, a build system control agent 13 associated with the originator of the event is determined. For example, the build system control agent 13 is a negotiation agent of the originator. In some embodiments, the build system control agent 13 includes data regarding an operation to be performed, for example, requirements and parameters of the build and the build environment, data privacy, and protection requirements. The build system control agent 13 is generated to negotiate with the BCI control agent 24, and in doing so, is configured to send a set of build system requirements for negotiation, for example, hardcoded as part of system-specific requirements, for example, set forth by a central controller 501 shown in FIG. 5. The build system control agent 13 can compare a checksum against the requirements.

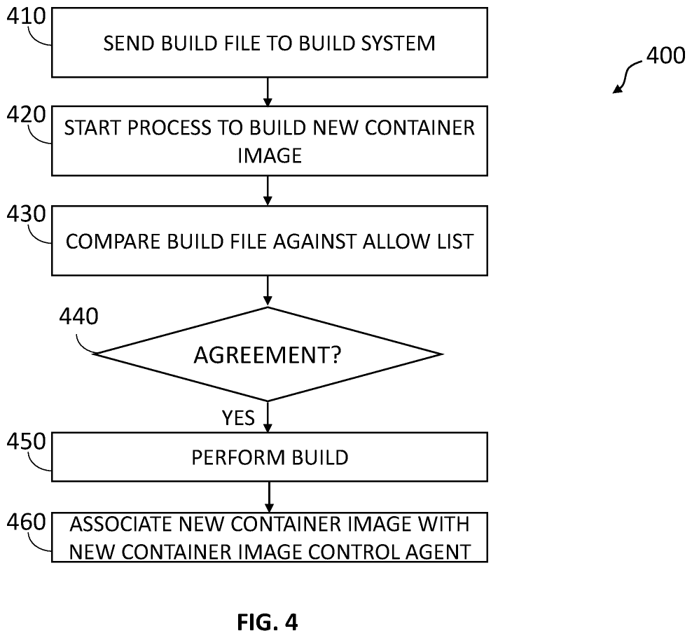

At step 340, a mutual negotiation protocol is facilitated between the BCI control agent 24 and the build system control agent 13. For example, each control agent may have predetermined goals, requirements, and constraints regarding a subsequent build operation, described in detail with respect to the method 400 of FIG. 4.

At step 350, at least one operation of a set of operations and operation parameters are determined from the mutual negotiation protocol exchanged in step 340. An operation is facilitated according to the parameters. For example, the new container image 31 may be constructed according to a parameter that establishes that a base container image can only be reused three times, or can only be transformed using a particular software version and more specifically, the NCI control agent 32 controlling the new container image 31. In other words, a new control agent is created for the new container image so future builds can be controlled.

At step 360, based on the negotiation, a set of requirements are determined for the NCI control agent 32. Information is identified that is associated with a set of operations including a set of parameters for each operation. Referring again to the previous example, the NCI control agent 32 can be configured to ensure that the new container image 31 can be used as a base image no more than three times.

At step 370, the NCI control agent 32 is created based on the requirements of step 360. The build system 12 also associates the NCI control agent 32 with the new container image 31 so that the new container image 31 is a controlled container image.

FIG. 4 is a flow chart of a method for electronic communication between control agents of a software container and a build system, in accordance with embodiments of the present invention. In some embodiments, an electronic communication includes the negotiation process described above.

At step 410, a user sends a build file to the build system control agent 13 and the build system 12, for example, the image retrieval and processing system 15, starts a process to build the new container image 31. If the build file references the base container image 22, then the base container image (BCI) control agent 24 initiates a negotiation process with the build system control agent 13 about a requested build. The negotiation process is performed according to a mutual negotiation protocol, for example, described in FIGS. 2 and 3. In doing so, the BCI control agent 24 requests attestation records pertaining to the BCI control agent 24 and its execution environment to verify the identity and integrity of the BCI control agent 24. To obtain the attestation records, the build system control agent 13 in some embodiments uses a local attestation service that is available in the execution environment where the build system control agent 13 is running. Attestation records are validated on the basis of requirements contained in the contract. This validation provides integrity to the build system 12. For example, the control agent accepts only a specific build.

At step 430, both parties, i.e., the BCI control agent 24 and build system control agent 13, can compare the build file against their respective build instruction allow list according to their particular requirements during the negotiation. As part of step 430, the requirements can be part of a series of negotiation steps. The requirements can be hardcoded in the respective the BCI control agent 24 or build system control agent 13, or retrieved from a central repository of the central controller 501 of FIG. 5 or other database.

The build file can include build instructions, requirements, and/or parameters. When the build system receives an allow list, it performs a check to determine how instructions execute against the list, and in response determines whether to operate. In one example, the build system can deny certain commands during the build process, and prohibit the execution of a build instruction. In another example, the build system can deny certain parameters of a command during the build process, if the parameters do not conform to the allow list.

At decision diamond 440, a determination is made if the build system control agent 13 and the BCI control agent 24 reach an agreement regarding the build file. The BCI control agent 24 does not agree if the comparison at step 430 produces a mismatch between the build file and the build instructions allow list. If agreement is reached, then at step 450, the build system 12 performs the build and retrieves the resulting new container image 31.

At step 460, the new container image 31 is processed so that the new container image 31 is associated with a new container image control agent 32.

At step 470, a new container image (NCI) control agent 32 and contract are created by the BCI control agent 24, which also embeds them into the new container image 31. In some embodiments, the BCI control agent 24 encrypts one or more layers of the image, to implement technical assurance that the container image can be used only through the BCI control agent 24. For example, the BCI control agent 24 copies the control agent implementation and contract from the base container image 22 to the new container image 13. As described above, the BCI control agent 24 may create a new data encryption key to encrypt the layers into the NCI control agent 32. In some embodiments, the BCI control agent 24 and/or build system control agent 13 can store evidence about the build and the negotiation in a blockchain or a data repository. For example, evidence of a build operation and negotiation information can be stored in a storage device associated with the BCI control agent 24 and/or build system control agent 13, such as a database, central repository, or blockchain. Subsequently, the new container image 31 is built after execution of method 400.

FIG. 5 is a block diagram illustrating an environment for building and controlling operations of container images using a central controller 501 communicating with a plurality of build systems 515-1 through-515-N, wherein N is an integer greater than 1), in accordance with embodiments of the present invention. In some embodiments, the central controller 501 includes a security processing system that provides cryptographic operations including cryptographic keys that render the layers of container images immutable and tamper resistant. In some embodiments, the central controller 501 can implement controller agents for association by the build systems with container images of interest. In some embodiments, the container image control agents are stored and executed external to the containers, for example, at the central controller 501. In some embodiments, the central controller 501 includes a controller manager that communicates with the build system control agents and/or container image control agents.

FIG. 6 depicts a schematic view of an environment for building and controlling operations of one or more container images according to a blockchain smart contract, in accordance with embodiments of the present invention.

As shown in FIG. 6, a container image control agent 602 and build system control agent 604 are parties to a smart contract 606, for example, described with reference to FIG. 2. A control agent executes the smart contract 606 during a negotiation process. The smart contract 606 is created and associated with a third control agent, for example, NCI control agent 32 of FIG. 1. The smart contract state and execution evidence, the negotiation state, and evidence and evidence of the outcome of reuse operations and the like are recorded in a blockchain 610. In some embodiments, the build system control agent or the base container image control agent stores evidence of the build operation in the blockchain 610. In some embodiments, the smart contract 606 is triggered by transaction events. The code corresponding to the smart contract 606 is uploaded to the blockchain 610 in a form of a transaction 608, and stored in a block of the distributed ledger. The smart contract 606 encapsulated in blockchain transactions is accessible to a control agent when forming and controlling subsequently built container images.

FIG. 7 illustrates an embodiment of a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 7 shows the computer system 90 as a particular configuration of hardware and software, any configuration of hardware and software, as would be known to a person of ordinary skill in the art, may be utilized for the purposes stated supra in conjunction with the particular computer system 90 of FIG. 7. For example, the memory devices 94 and 95 may be portions of a single memory device rather than separate memory devices.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

FIG. 8 depicts a computing environment 100 which contains an example of an environment for the execution of at least some of the computer code involved in performing the inventive methods, in accordance with embodiments of the present invention. Such computer code includes new code for controlling container image operations 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 8. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for building container images, the computer-implemented method comprising:
determining, by one or more processors of a computer system, a base container image control agent associated with a base container image;
determining, by one or more processors of a computer system, a build system control agent associated with a build system;
facilitating, by the one or more processors of the computer system, a mutual negotiation protocol between the base container image control agent and the build system control agent;
determining, by the one or more processors of the computer system, a set of operation parameters in response to facilitating the mutual negotiation protocol;
identifying, by the one or more processors of the computer system, from the set of operation parameters a set of requirements for a new container image control agent; and
generating a new container image based on the operation parameters to which the new container image control agent is associated.

2. The computer-implemented method of claim 1, further comprising:
detecting, by the one or more processors of the computer system, an event; and
identifying the build system control agent associated with an originator of the event.

3. The computer-implemented method of claim 1, wherein the base container image control agent controls an instantiation of at least one of a reuse, derivation or evolution lifecycle of the base container image with respect to the new container image.

4. The computer-implemented method of claim 1, further comprising:
creating, by the base container image control agent, a data encryption key to encrypt one or more layers of the base container image.

5. The computer-implemented method of claim 1, further comprising:
forming a smart contract by an owner of the base container image control agent and an owner of the build system control agent to which the base container image control agent and the build system control agent are associated, wherein the smart contract defines negotiation goals, requirements, and constraints for the mutual negotiation protocol.

6. The computer-implemented method of claim 1, wherein facilitating the mutual negotiation protocol comprises:
requesting, by the build system control agent, a build file;
comparing the build file against an allow list;
determining, in response to the comparison, an agreement between the build system control agent and the base container image control agent; and
performing, by the build system, a build operation including retrieving the new container image for association with the new container image control agent.

7. The computer-implemented method of claim 6, further comprising:
storing, by the build system control agent or the base container image control agent, evidence of the build operation in a blockchain.

8. The computer program product method of claim 6, further comprising:
storing, by the build system control agent or the base container image control agent, evidence of the build operation and negotiation in a storage device associated with the build system control agent or the base container image control agent.

9. A computer program product, comprising one or more computer readable hardware storage devices having computer readable program code stored therein, said program code containing instructions executable by one or more processors of a computer system to implement a method for building container images, said method comprising the steps of:
determining, by one or more processors of a computer system, a first base image control agent associated with a first container image;
invoking, by the one or more processors of the computer system, a first build system control agent, to generate a second container image from the first container image;
facilitating, by the one or more processors of the computer system, a mutual negotiation protocol between the first base image control agent and the first build system control agent;
determining, by the one or more processors of the computer system, a set of operation parameters in response to facilitating the mutual negotiation protocol;
identifying, by the one or more processors of the computer system, from the set of operation parameters a set of requirements for at least one third controller agent;
creating, by the one or more processors of the computer system, a second base image control agent for the second container image using the set of requirements; and
executing, by the one or more processors of the computer system, the second container image controlled by the second base image control agent.

10. The computer program product of claim 9, wherein the method further comprises:
detecting, by the one or more processors of the computer system, an event; and
identifying the build system control agent associated with an originator of the event.

11. The computer program product of claim 9, wherein the base container image control agent controls an instantiation of at least one of a reuse, derivation or evolution lifecycle of the base container image with respect to the new container image.

12. The computer program product of claim 9, wherein the method further comprises:
creating, by the base container image control agent, a data encryption key to encrypt one or more layers of the base container image.

13. The computer program product of claim 9, wherein the method further comprises:
forming a smart contract by an owner of the base container image control agent and an owner of the build system control agent to which the base container image control agent and the build system control agent are associated, wherein the smart contract defines negotiation goals, requirements, and constraints for the mutual negotiation protocol.

14. The computer program product of claim 9, wherein facilitating the mutual negotiation protocol comprises:
requesting, by the build system control agent, a build file;
comparing the build file against an allow list;
determining, in response to the comparison, an agreement between the build system control agent and the base container image control agent; and
performing, by the build system, a build operation including retrieving the new container image for association with the new container image control agent.

15. A computer system, comprising one or more processors, one or more memories, and one or more computer readable hardware storage devices, said one or more hardware storage devices containing program code executable by the one or more processors via the one or more memories to implement a method for building container images, said method comprising the steps of:
determining, by one or more processors of a computer system, a first base image control agent associated with a first container image;
invoking, by the one or more processors of the computer system, a first build system control agent, to generate a second container image from the first container image;
facilitating, by the one or more processors of the computer system, a mutual negotiation protocol between the first base image control agent and the first build system control agent;
determining, by the one or more processors of the computer system, a set of operation parameters in response to facilitating the mutual negotiation protocol;
identifying, by the one or more processors of the computer system, from the set of operation parameters a set of requirements for at least one third controller agent;
creating, by the one or more processors of the computer system, a second base image control agent for the second container image using the set of requirements; and
executing, by the one or more processors of the computer system, the second container image controlled by the second base image control agent.

16. The computer system of claim 15, wherein the method further comprises:
detecting, by the one or more processors of the computer system, an event; and
identifying the build system control agent associated with an originator of the event.

17. The computer system of claim 15, wherein the base container image control agent controls an instantiation of at least one of a reuse, derivation or evolution lifecycle of the base container image with respect to the new container image.

18. The computer system of claim 15, wherein the method further comprises:
creating, by the base container image control agent, a data encryption key to encrypt one or more layers of the base container image.

19. The computer system of claim 15, wherein the method further comprises:
forming a smart contract by an owner of the base container image control agent and an owner of the build system control agent to which the base container image control agent and the build system control agent are associated, wherein the smart contract defines negotiation goals, requirements, and constraints for the mutual negotiation protocol.

20. The computer system of claim 15, wherein facilitating the mutual negotiation protocol comprises:
requesting, by the build system control agent, a build file;
comparing the build file against an allow list;
determining, in response to the comparison, an agreement between the build system control agent and the base container image control agent; and
performing, by the build system, a build operation including retrieving the new container image for association with the new container image control agent.
